(19) United States
(12) Patent Application Publication
(10) Pub. No.: US 2025/0042823 A1
(43) Pub. Date: Feb. 6, 2025

(54) SOLVENT FREE METHOD OF PRODUCING UREA ADDUCT

(71) Applicant: Lehigh University, Bethlehem, PA (US)

(72) Inventors: Jonas BALTRUSAITIS, Allentown, PA (US); Kenneth Edward HONER, Hellertown, PA (US)

(73) Assignee: Lehigh University, Bethlehem, PA (US)

(21) Appl. No.: 18/923,442

(22) Filed: Oct. 22, 2024

Related U.S. Application Data
(63) Continuation of application No. 16/640,419, filed on Feb. 20, 2020, now Pat. No. 12,129,215.
(60) Provisional application No. 62/548,145, filed on Aug. 21, 2017.

(51) Int. Cl. C05C 9/00; C05C 1/02; C05C 3/00; C05G 5/40

(52) U.S. Cl. CPC C05C 9/005; C05C 1/02; C05C 3/005; C05G 5/40

(57) ABSTRACT

Described herein are agricultural compositions comprising an adduct of urea comprising: urea; and an inorganic salt; wherein the adduct has an average particle size ranging from about 0.1 microns to about 10 microns.

### CROSS-REFERENCE TO RELATED APPLICATION

This application claims the benefit of priority from U.S. Provisional Application No. 62/548,145, filed Aug. 21, 2017, the contents of which are hereby incorporated herein by reference in their entirety.

### BACKGROUND

Urea is a large volume nitrogen containing fertilizer but suffers from a propensity to hydrolyze in soil under atmospheric conditions of relative humidity, thereby resulting in nitrogen losses to environment. Therefore, a need exists to better improve upon the poor storage stability of urea fertilizer so that nitrogen, as well as other compounds suitable for plant fertilization, is not premature lost after implantation into soil.

### SUMMARY

Described herein is an agriculture composition comprising: an adduct of urea comprising: urea; and an inorganic salt; wherein the adduct has an average particle size ranging from about 0.1 microns to about 10 microns.

Some embodiments of the present invention include a method of manufacturing an agriculture composition comprising: a) forming a blend of urea and an inorganic salt, whereby the blend is substantially free of solvent; b) subjecting the blend to a solventless mechanochemical process such that the urea and inorganic salt react to form an adduct of urea and inorganic salt; and c) forming crystalline material comprising the adduct of urea and inorganic salt.

Other embodiments of the present invention include a blend composition comprising: urea; inorganic salt; wherein the blend composition is substantially free of solvent, and the urea and inorganic salt are present in a molar ratio ranging from about 1:4 to about 6:1.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the claimed invention.

### BRIEF DESCRIPTION OF THE DRAWINGS

The present invention will become more fully understood from the detailed description and the accompanying drawings, wherein:

FIG. 1 is a graphical representation of residual deposit amounts of nitrogen in the form of ammonium ion in soil over the course of 2 weeks, 4 weeks, and 6 weeks;

FIG. 2 is a graphical representation of residual deposit amounts of nitrogen in the form of nitrate and nitrite ions in soil over the course of 2 weeks, 4 weeks, and 6 weeks;

FIG. 3 is a graphical representation of residual deposit amounts of nitrogen in the form of mineral nitrogen in soil over the course of 2 weeks, 4 weeks, and 6 weeks;

FIG. 4 is a graphical representation of residual deposit amounts of sulfur in soil over the course of 2 weeks, 4 weeks, and 6 weeks; and

FIG. 5 is a graphical representation of gaseous NH₃ concentration resulting from the decomposition of a urea adduct in soil (1 mg N/g soil) of the present invention vs. pure urea.

### DETAILED DESCRIPTION

The following description of the preferred embodiment(s) is merely exemplary in nature and is in no way intended to limit the scope of the claimed invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means ±/−5% of the reference value. According to the present application, the term “substantially free” less than about 0.1 wt. % based on the total of the referenced value.

The present invention is directed to a urea-adduct formed by a solventless process. As described further herein, the urea-adduct may be suitable for use as a fertilizer, whereby the fertilizer exhibits improved stability in that the urea-adduct does not prematurely hydrolyze causing unwanted release of nitrogen compounds.

In some embodiments, the urea-adducts of the present invention may be formed by first creating a dry-blend of a first component and a second component. The first component may comprise urea, urea acid compounds, such as urea nitrate, urea phosphate, urea sulphate, and mixtures thereof. The second component may comprise inorganic salt, metal oxides, metal hydroxides, and metal carbonates. As used herein, “dry-blend” refers to a blend being substantially free of solvent. As used herein, the term “solventless” refers to a blend being substantially free of solvent. The solvent may include any substance capable of dissolving the urea and/or inorganic salt. Non-limiting examples of solvent may include water, organic solvents, VOC-containing solvents, and mixtures thereof.

The dry-blend of the urea and the second component may then be subjected to a mechanochemical step, whereby the dry-blend is agitated for a period of time and at a mechano-synthesis temperature, which is about room temperature (e.g., about 18° C. to 25° C.). The mechanochemical time may range from about 5 minutes to about 120 minutes-including all times and sub-ranges therebetween. The mechano-synthesis temperature may range from about 20° C. to about 32° C.—including all times and sub-ranges therebetween. In a non-limiting example, the mechanochemical step may be performed in a grinding apparatus, such as a ball mill.

According to some embodiments of the present invention, the dry-blend may undergo agitation at the mechano-synthesis temperature for the mechanochemical time until the urea and the second component undergo chemical conversion from being a physical blend of urea and the second component to the urea adduct of the present invention.

As used herein, the term “urea adduct” refers to a single chemical compound that is formed from at least two distinct starting materials-whereby the starting materials of the present invention correspond to the individual compounds of the urea or urea acids and the individual compounds of the inorganic salt, metal oxides, metal hydroxides, and metal carbonates. In some embodiments, the urea adduct is a single reaction product containing all atoms of the two distinct starting materials, whereby a chemical bond is formed between the starting materials such that the resultant urea adduct is a distinct molecular species created from the corresponding starting materials (e.g. the urea source and the inorganic salt).

The resulting urea adduct may exhibit a crystalline structure that is distinct from each of the distinct starting molecules. Therefore, according to the present invention, the first component starting molecule (also referred to as “urea starting component”) may exhibit a first crystal lattice structure, the second component starting molecule may exhibit a second crystal lattice structure, and the urea adduct may exhibit a third crystal lattice structure. For example, the second crystal lattice structure may refer to the crystal lattice structure of one or more inorganic salts (e.g., calcium sulfate), metal oxides (e.g., magnesium oxide), metal hydroxides (e.g., calcium hydroxide), and/or metal carbonates (e.g., calcium carbonate). The third crystal lattice structure may be completely distinct from each of the first and second lattice structures.

The first starting component is a urea compound. According to the present invention, suitable urea compounds may include urea (CO(NH₂)₂); urea phosphate; urea nitrate; urea sulfate and mixtures thereof. Urea sulfate may be the product of urea and sulfuric acid in a molar ratio ranging from about 1:2 to about 2:1—including all ratios and sub-ranges there-between. Urea sulfate may be the product of urea and sulfuric acid in a molar ratio of about om about 2:1. Urea sulfate may be the product of urea and sulfuric acid in a molar ratio of about om about 1:1. Urea sulfate may be the product of urea and sulfuric acid in a molar ratio of about om about 1:2.

The second starting component may be an inorganic salt. Inorganic salts comprise an anion and cation. In a non-limiting embodiment, the cation of the inorganic salt may be selected from a calcium-containing ion, magnesium-containing ion, and combinations thereof. In a non-limiting embodiment, the anion is selected from a sulfate-containing ion, a bis (dihydrogen phosphate)-containing ion, a nitrate-containing ion, and combinations thereof.

Non-limiting examples of the inorganic salt may include magnesium sulfate (MgSO₄); calcium sulfate (CaSO₄); calcium bis (dihydrogen phosphate) (Ca(H₂PO₄)₂); calcium nitrate (Ca(NO₃)₂), and mixtures thereof. Additionally, the inorganic salt may be a low-soluble inorganic salt, such as MgCO₃ (magnesite) or MgOH₂ (brucite). Additionally said examples include hydrated water molecule containing magnesium or calcium salts, such as CaSO₄·2H₂O or Ca(NO₃)₂·4H₂O.

Non-limiting examples of other second starting components include calcium hydroxide (Ca(OH)₂); magnesium hydroxide (Mg(OH)₂); calcium oxide (CaO); magnesium oxide (MgO); calcium carbonate (CaCO₃); magnesium carbonate (MgCO₃).

In producing the urea adduct, the dry-blend may comprise the urea starting component and the inorganic salt starting component in a weight ratio ranging from about 1:4 to about 6:1—including all ratios and subranges there-between. In a preferred embodiment, the dry-blend may comprise the urea starting component and the inorganic salt starting component in a weight ratio ranging from about 1:1 to about 6:1—including all ratios and subranges there-between. In an even more preferred embodiment, the urea starting component is in a stoichiometric excess to the inorganic salt starting component. In some embodiments, the dry-blend comprises the urea starting component and the inorganic salt starting component in a weight ratio ranging from about 1.1:1 to about 4:1, alternatively from about 1.5:1 to 4:1, alternatively from about 2:1 to about 4:1, alternatively from about 3:1 to 4:1, alternatively about 4:1—including all ratios and subranges there-between.

In a non-limiting embodiment, the urea adduct formed by the solventless process may be one or more of the following crystalline compounds: CaSO₄·4urea; Ca(H₂PO₄)₂·4urea; Ca(NO₃)₂·4urea; MgSO₄·6urea·0.5H₂O, Mg(H₂PO₄)₂·4urea; and Mg(NO₃)₂·4urea·2H₂O.

In a non-limiting embodiment, the solventless process may comprise loading CaSO₄·2H₂O and urea mixture in 1:4 molar ratio into stainless steel jar together with one or more stainless steel balls and shaking it for 5 min at 26 Hz. The resulting powder may have a 100% conversion from the urea starting molecule and the inorganic salt starting molecule to the urea adduct.

According to the present invention, the solventless production of the urea adduct provides a number of advantages over solvent-based production. Firstly, using the mechanochemical milling process, the urea adduct may be produced in times of up to 10 minutes, which is a vast improvement over solvent-based processes. Secondly, higher yield rates have been achieved using a solventless production as compared to a solvent-based process. Furthermore the starting components have less restrictions in terms of solubility, as soluble and non-soluble inorganic salts may be used to form the urea adduct. With less restrictions on starting material, the urea adduct may be produced from a wider variety of starting materials. In a non-limiting example, the inorganic salt starting molecule may be calcium sulfate originating from gypsum board waste (i.e. drywall waste) or calcium sulfate originating from coal fired powerplant waste.

After completing the mechanochemical process, the resulting urea adduct may be in the form of a crystalline powder having the third lattice structure. The crystalline power may have a particle size ranging from about 0.1 microns to about 10 microns including all particle sizes and sub-ranges there-between. In a preferred embodiment, the crystalline power may have a particle size ranging from about 0.5 microns to about 5 microns—including all particle sizes and sub-ranges there-between.

The urea adduct may have a solubility parameter ranging from about 10 g/L to about 1079 g/L as measured at 20° C.—including all solubilities and sub-ranges there-between. The particles that make up crystalline powder of the urea adduct may have a surface area ranging from about 0.5 m2/g to about 10 m2/g—including all surface areas and sub-ranges there-between. In a preferred embodiment, the particles that make up crystalline powder of the urea adduct may have a surface area ranging from about 1 m2/g to about 5 m2/g—including all surface areas and sub-ranges there-between.

In some embodiments of the present invention, the urea adduct may be produced with the solventless method by utilizing room temperature solid organic acids as a starting component—such as tartaric acid, succinic acid, oxalic acid, and mixtures thereof.

The urea adduct of the present invention may be particularly suitable as an agricultural composition. In a non-limiting embodiment, the agricultural composition may be a fertilizer. The fertilizer may be substantially free of paraffin wax. The urea adduct in the fertilizer may have a pH ranging from about 5 to about 8—including all pH values and sub-ranges there-between. Fertilizers comprising the urea adduct may further comprise one or more other components such as ammonium nitrate, ammonium sulfate, ammonium thiosulfate, and mixtures thereof. The fertilizer may have a pH ranging from about 5 to about 8—including all pH values and sub-ranges there-between.

The agricultural composition may comprise a crystalline matrix, whereby the adduct of urea is embedded within the crystalline matrix. The crystalline matrix may be a controlled-release matrix such that the controlled-release matrix controls the release of an element from the agricultural composition. The agricultural composition according to claim 21, wherein the element is selected from: nitrogen, sulfur, ammonium. The controlled-release matrix is selected from an extended-release matrix and a delayed-release matrix.

The urea adduct may be post-processed when being formed into a fertilizer such that the fertilizer comprises particles formed from the urea adduct, wherein the fertilize particles have an average particle size ranging from about 0.5 mm to about 10 mm including all sizes and sub-ranges there-between. In a preferred embodiment, the fertilizer comprises particles formed from the urea adduct, wherein the fertilize particles have an average particle size ranging from about 1 mm to about 5 mm—including all sizes and sub-ranges there-between.

The fertilizer according to the present invention may be implanted into ground soil that is later to be sowed with seeds and/or embedded with plants that will be grow into flowers, food crops, and the like. In other embodiments, the fertilizer according to the present invention may be pre-blended with soil, whereby the premixed fertilizer soil may be sold as an off-the shelf composition to later be added to a farm, home garden, plant potter, and the like.

As those skilled in the art will appreciate, numerous changes and modifications may be made to the embodiments described herein, without departing from the spirit of the invention. It is intended that all such variations fall within the scope of the invention.

The following examples were prepared in accordance with the present invention. The present invention is not limited to the examples described herein.

### EXAMPLES

### Example 1

A first experiment was performed that included the test the potency and concentration stability and of exemplary urea adducts of the present invention. The tests described herein are useful in determining how the urea adducts of the present invention will perform as agricultural compositions (e.g. a fertilizer).

The urea adduct exemplified herein (referred to as Example 1) was produced by first creating a dry blend (i.e., no solvent) of urea and an inorganic salt of calcium sulfate dihydrate (CaSO₄·H₂O), followed by placing the dry blend into a ball mill. The blend was then agitated in the ball mill for a period of about 10 minutes, thereby causing the urea and inorganic salt to react and form the urea adduct cocrystal powder of the present invention. The resulting adduct had a particle size of about 1 micron and a surface area of about 3 m²/g. The resulting urea adduct was dried at room temperature overnight.

A control and multiple comparative compositions were prepared to compare the potency and concentration stability of the urea adduct. For this experiment, a NPK fertilizer is used as the control, whereby the NPK fertilizer comprises nitrogen, phosphorus, and potassium. A first comparative composition (referred to as Comparative Example 1) is urea. A second comparative composition (referred to as Comparative Example 2) is a physical blend (i.e., not an adduct) of urea and ammonium sulfate ((NH₄)₂SO₄). A third comparative composition (referred to as Comparative Example 3) is a physical blend (i.e., not an adduct) of urea and inorganic salt that is calcium sulfate.

Each of Example 1, the Control, and Comparative Examples 1-3 were planted into soil and corn was grown. Soil chemical analysis was performed sampled from 0-30 nm depth every 2 weeks up to 6 weeks. Specific measurements of N (NH₄⁺; NO₂⁻+NO₃⁻; mineral N) and sulfur were recorded.

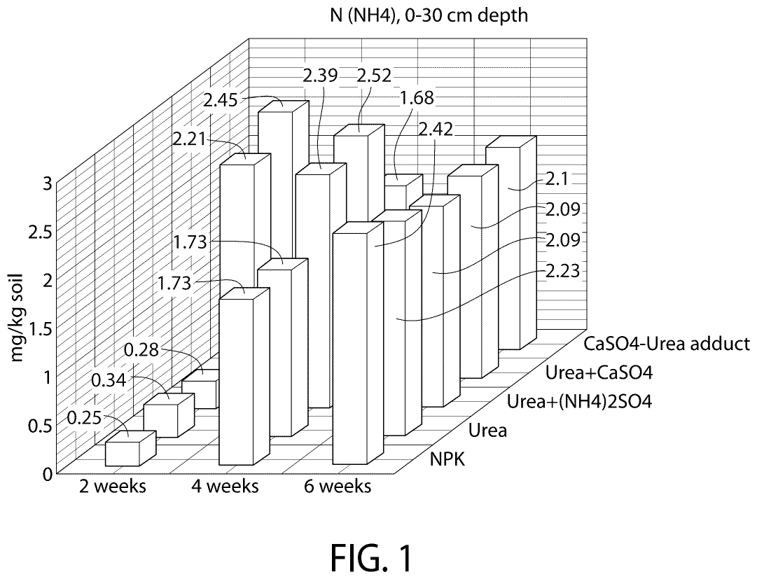

The results of the nitrogen evaluation tests are set forth in FIGS. 1-3 as well as below in Tables 1-4. Specifically, Table 1 sets forth the nitrogen stability in the urea-adduct and comparative compositions, as measured by the ammonium content in the surrounding soil (mg of ammonium per kilogram of soil). The results are also provided in graphical form in FIG. 1.

TABLE 1
Nitrogen Stability As Measured by Ammonium Content In Soil

| | 2 Weeks | 4 Weeks | 6 Weeks | Total % Change |
|---|---|---|---|---|
| Ex. 1 | 2.45 | 2.52 | 2.1 | −14.3% |
| Control | 0.25 | 1.73 | 2.42 | +868% |
| Comp. Ex. 1 | 0.34 | 1.73 | 2.23 | +555% |
| Comp. Ex. 2 | 0.28 | 2.39 | 2.09 | +646% |
| Comp. Ex. 3 | 2.21 | 2.52 | 2.09 | −5.4% |

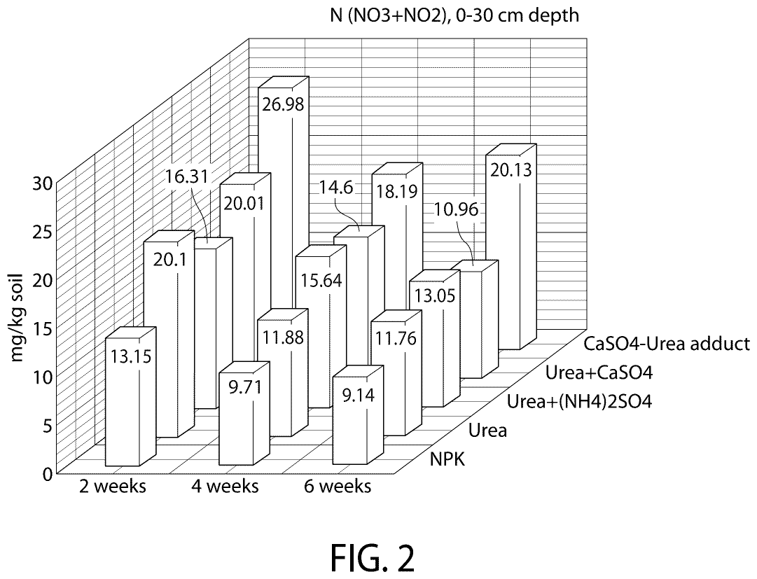

Table 2 sets forth the nitrogen stability in the urea-adduct and comparative compositions, as measured by the nitrate and nitrite ion content in the surrounding soil (mg of nitrate and nitrite per kilogram of soil). The results are also provided in graphical form in FIG. 2.

TABLE 2
Nitrogen Stability As Measured by NO₃ & NO₃ Content In Soil

| | 2 Weeks | 4 Weeks | 6 Weeks | Total % Change |
|---|---|---|---|---|
| Ex. 1 | 26.98 | 18.19 | 20.13 | −25.3% |
| Control | 13.15 | 9.71 | 9.14 | −30.5% |
| Comp. Ex. 2 | 20.1 | 11.88 | 11.76 | −41.5% |
| Comp. Ex. 3 | 16.31 | 15.64 | 13.05 | −20.0% |
| Comp. Ex. 4 | 20.01 | 14.6 | 10.96 | −45.3% |

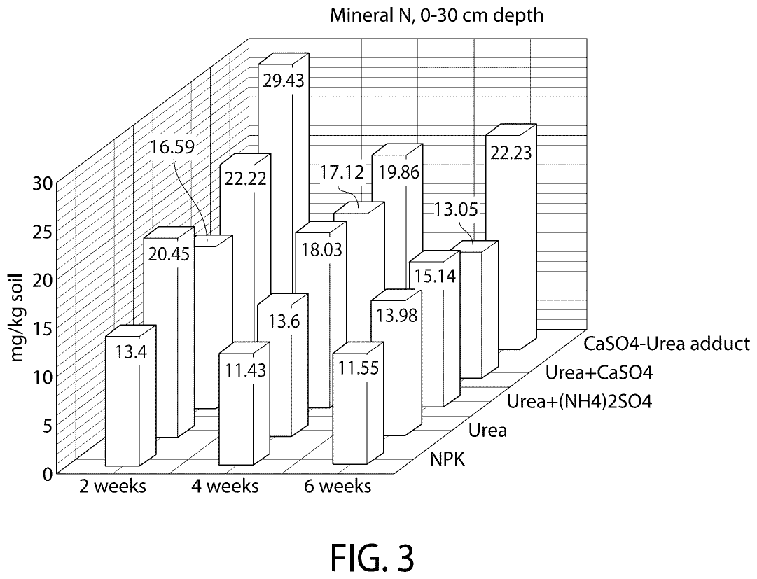

Table 3 sets forth the nitrogen stability in the urea-adduct and comparative compositions, as measured by the mineral nitrogen content in the surrounding soil (mg of mineral nitrogen per kilogram of soil). The results are also provided in graphical form in FIG. 3.

TABLE 3
Nitrogen Stability As Measured by
Mineral Nitrogen Content In Soil

| | 2 Weeks | 4 Weeks | 6 Weeks | Total % Change |
|---|---|---|---|---|
| Ex. 1 | 29.43 | 19.86 | 22.23 | −24.5% |
| Control | 13.4 | 11.43 | 11.55 | −13.8% |
| Comp. Ex. 1 | 20.45 | 13.6 | 13.98 | −31.6% |
| Comp. Ex. 2 | 16.59 | 18.03 | 15.14 | −2.7% |
| Comp. Ex. 3 | 22.22 | 17.12 | 13.05 | −41.3% |

As demonstrated by Tables 1-3, the urea adduct of the present invention exhibited a nitrogen concentration stability at six weeks that equates to about 25% or less in total drop of nitrogen concentration (as measured by ammonium, NO₂, NO₃, or mineral nitrogen in the soil) as compared to the comparative composition that exhibited a drop greater than 25% in at least one of the ammonium, NO₂, NO₃, and/or mineral nitrogen tests. A summary of the test results for Tables 1, 2, and 3 are set forth below in Table 4.

TABLE 4

| | | | Comp. | Comp. | Comp. |
|---|---|---|---|---|---|
| | Ex. 1 | Control | Ex. 1 | Ex. 2 | Ex. 3 |
| Ammonium | −14.3% | +868% | +555% | +646% | −5.4% |
| NO₂ & NO₃ | −25.3% | −30.5% | −41.5% | −20.0% | −45.3% |
| Mineral Nitrogen | −24.5% | −13.8% | −31.6% | −2.7% | −41.3% |

As demonstrated by Table 4, the urea adduct of the present invention surprisingly exhibits superior nitrogen concentration stability in that in all three nitrogen concentration evaluations—(ammonium, NO₂, NO₃, and/or mineral nitrogen), all evaluations exhibit a maximum concentration change of about 25%. The control and comparative compositions, however, exhibited at least one nitrogen concentration evaluation that was greater than about 25%, sometimes being an order of magnitude greater. For instance, Comparative Example 2 performed well in the mineral concentration evaluation yet performed extremely poorly in the ammonium concentration evaluation. Alternatively, Comparative Example 3 performed well in the ammonium concentration evaluation yet exceeded the 25% threshold in both the mineral nitrogen evaluation as well as the NO₂ and NO₃ evaluation.

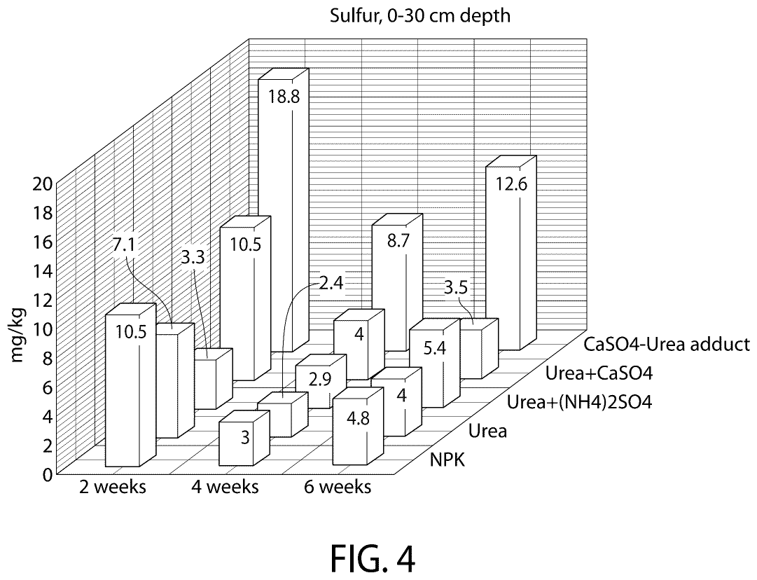

The results of the sulfur evaluation test is set forth in FIG. 4 as well as below in Table 5.Table 5 sets forth the sulfur stability in the urea-adduct and comparative compositions, as measured by the sulfur content in the surrounding soil (mg of sulfur per kilogram of soil). The results are also provided in graphical form in FIG. 4.

TABLE 5
Sulfur Stability As Measured by Sulfur Content In Soil

| | 2 Weeks | 4 Weeks | 6 Weeks | Total % Change |
|---|---|---|---|---|
| Ex. 1 | 18.8 | 8.7 | 12.6 | −33.0% |
| Control | 10.5 | 3 | 4.8 | −54.3% |
| Comp. Ex. 1 | 7.1 | 2.4 | 4.0 | −46.7% |
| Comp. Ex. 2 | 3.3 | 2.9 | 5.4 | −63.6% |
| Comp. Ex. 3 | 10.5 | 4.0 | 3.5 | −66.7% |

As demonstrated by Table 5, the urea adduct of the present invention exhibited a sulfur concentration stability at six weeks that equates to a drop in sulfur concentration that is about 33% or less as compared to the Control and/or Comparative Examples 1-3 that exhibited a drop of at least 46.7%. This experiment unambiguously shows that the urea adduct cocrystal of the present invention exhibits increased stability and longevity in soils.

### Example 2

A second experiment was performed to test the effects of solventless production of the urea adduct of the present invention.

A first urea adduct of this experiment (referred to as Example 2) was prepared by loading a total 200 mg of CaSO₄·2H₂O and urea solventless mixture in 1:4 molar ratio into 15 mL stainless steel jar together with 3 individual 8 mm stainless steel balls and shaking it for 10 mins at 26 Hz. The resulting powder analyzed using powder XRD shows 100% conversion of the parent compounds into CaSO₄·4urea.

A second urea adduct of this experiment (referred to as Example 3) was prepared by loading a total 200 mg of recycled drywall gypsum and urea mixture in 1:4 molar ratio into 15 mL stainless steel jar together with 3 individual 8 mm stainless steel balls and shaking it for 10 mins at 26 Hz. The resulting powder analyzed using powder XRD shows 100% conversion of the parent compounds into CaSO₄·4urea.

A third urea adduct of this experiment (referred to as Example 4) was prepared by loading a total 400 mg of Ca(OH)₂, urea phosphate, and urea mixture in 1:2:2 molar ratio into 15 mL stainless steel jar together with 3 individual 8 mm stainless steel balls and shaking it for 10 min at 26 Hz. The resulting powder analyzed using powder XRD shows 100% conversion of the parent compounds into Ca(H₂PO₄)₂·4urea.

A fourth urea adduct of this experiment (referred to as Example 5) was prepared by loading a total 600 mg of MgO, urea sulfate, and urea mixture in 1:2:2 molar ratio into 15 mL stainless steel jar together with 3 individual 8 mm stainless steel balls and shaking it for 10 min at 26 Hz. The resulting powder analyzed using powder XRD shows 100% conversion of the parent compounds into MgSO₄·6urea.0.5H₂O.

A fifth urea adduct of this experiment (referred to as Example 6) was prepared by loading a total 600 mg of Mg(OH)₂ urea nitrate and urea mixture in 1:2:2 molar ratio into 15 mL stainless steel jar together with 3 individual 8 mm stainless steel balls and shaking it for 30 seconds at 26Hz. The resulting powder analyzed using powder XRD shows a high conversion (>80%) of the parent compounds into Mg(NO₃)₂·urea·2H₂O.

A sixth urea adduct of this experiment (referred to as Example 7) was prepared by loading a total 600 mg of MgCO₃ urea nitrate and urea mixture in 1:2:2 molar ratio into 15 mL stainless steel jar together with 3 individual 8 mm stainless steel balls and shaking it for 30 seconds at 26Hz. The resulting powder analyzed using powder XRD shows a high conversion (>80%) of the parent compounds into Mg(NO₃)₂·urea·2H₂O.

A seventh urea adduct of this experiment (referred to as Example 8) was prepared by loading a total of 200 mg of tartaric acid and urea mixture in 1:1 molar ratio into 15 mL stainless steel jar together with 3 individual 8 mm stainless steel balls and shaking it for 10 mins at 26 Hz. The resulting powder analyzed using powder XRD shows 100% conversion of the parent compounds into urea· tartaric acid adduct

### Example 3

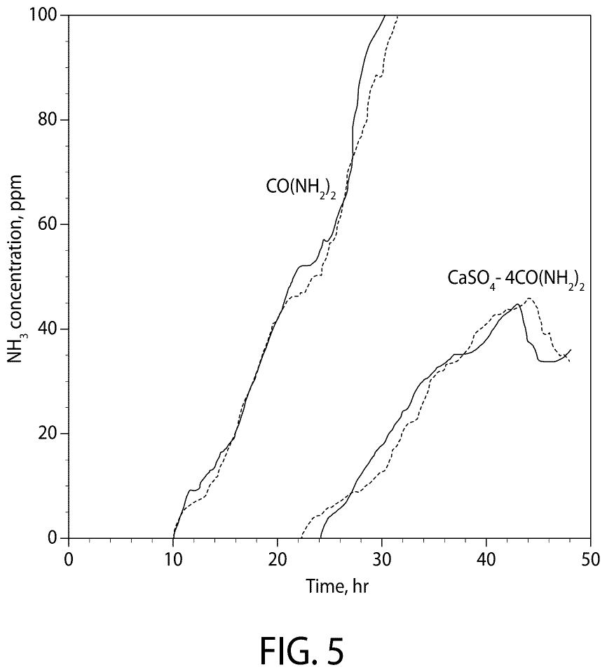

The urea adduct of Example 3 was evaluated for nitrogen stability by placing each of a pure urea composition as well as the urea adduct of Example 3 into separate closed reactors. Each composition were loaded into the closed reactor at 1 mg nitrogen (N) per 1 gram of soil. As demonstrated by the chart in FIG. 5. the urea adduct of the Example 3 exhibit a decreased NH₃ emissions, as compared to the pure urea. Therefore, the urea adduct of Example 3 is particularly suitable for use as improved fertilizer.

1-57. (canceled).

58. A method of manufacturing an agriculture composition comprising:
a) forming a blend of urea and an inorganic salt, whereby the blend is substantially free of solvent;
b) subjecting the blend to a mechanochemical process such that the urea and inorganic salt react to form an adduct of urea and inorganic salt; and
c) forming crystalline material comprising the adduct of urea and inorganic salt.

59. The method according to claim 58, further comprising step d) wherein the crystalline material formed in step c) is post-processed into particle having an average particle size ranging from about 1 mm to about 5 mm.

60. The method according to claim 58, wherein the mechanochemical process of step b) comprises ball-milling the blend of urea and inorganic salt.

61. The method according to claim 58, wherein the inorganic salt is comprising a cation and an anion.

62. The method according to claim 58, wherein the urea and inorganic salt are present in the adduct in a molar ratio ranging from about 6:1 to about 1:6.

63. The method according to claim 58, wherein the inorganic salt comprises a cation and an anion.

64. The method according to claim 63, wherein the cation is selected from a calcium-containing ion, magnesium-containing ion, and combinations thereof.

65. The method according to claim 63, wherein the anion is selected from a sulfate-containing ion, a dihydrophosphate-containing ion, a nitrate-containing ion, and combinations thereof.

66. The method according to claim 58, wherein the inorganic salt is obtained from calcium sulfate containing drywall gypsum waste or coal fired power plant solid absorber waste.

67. The method according to claim 58, further comprising a neutralization step, wherein starting components include a magnesium and calcium source obtained from at least one of metal oxides, metal hydroxides, and metal carbonates.

68. The method according to claim 58, wherein the adduct of urea and inorganic salt comprises Ca(H₂PO₄)₂·H₂O.

69. The method according to claim 68, further comprising a neutralization step, whereby residual free H₃PO₄ in the Ca(H₂PO₄)₂·H₂O) is converted to additional Ca(H₂PO₄)₂ by: (i) the addition of a calcium compound selected from: Ca(OH)₂; CaCO₃; CaO; and a combination of two or more thereof; and (ii) and milling the product of step (1).

70. The method according to claim 58, wherein the urea is selected from: urea nitrate, urea phosphate, urea sulphate, and a combination of two or more thereof.

71. The method according to claim 58, wherein the inorganic salt is selected from: a metal oxide; a metal hydroxide; a metal carbonate; and a combination of two or more thereof.

72. The method according to claim 60, wherein the ball-milling comprises the use of balls of metallic or metallic alloy composition to provide kinetic energy to the solventless blend of urea and an inorganic salt.

73. The method according to claim 69, wherein the Ca(H₂PO₄)₂·H₂O is mixed with from about 5 wt. % to about 20 wt. % of the calcium compound.
